(19) United States
(12) Patent Application Publication
(10) Pub. No.: US 2017/0070625 A1
(43) Pub. Date: Mar. 9, 2017

(54) INFORMATION PROCESSING APPARATUS, AUTOMATIC SETTING METHOD

(71) Applicant: KYOCERA Document Solutions Inc., Osaka (JP)

(72) Inventors: Mark Jefferson Yee, Cebu (PH); Jasser Mark Arioste, Osaka (JP); Adrian Dela Piedra, Osaka (JP)

(21) Appl. No.: 15/257,738

(22) Filed: Sep. 6, 2016

(30) Foreign Application Priority Data
Sep. 8, 2015 (JP) 2015-176364

(51) Int. Cl. H04N 1/00; H04N 1/32; G06K 15/00

(52) U.S. Cl. CPC H04N 1/00517; G06K 15/005; H04N 1/32106; H04N 1/00411; H04N 1/00482; H04N 1/00514; H04N 1/0097; H04N 2201/0094

(57) ABSTRACT

In an information processing apparatus, a storage processing portion overwrites and stores, every time an informational process is executed, contents of one or more settings items as a single history data-set stored in a storage portion. The count processing portion counts the total number of times the informational process has been consecutively set and executed with contents identical to the contents of the settings items in the history data-set. The second settings-processing portion sets the contents of the settings items in the history data-set as the initial-settings contents when the total number of times counted by the count processing portion has reached a threshold set in advance.

INCORPORATION BY REFERENCE

This application is based upon and claims the benefit of priority from the corresponding Japanese Patent Application No. 2015-176364 filed on Sep. 8, 2015, the entire contents of which are incorporated herein by reference.

### BACKGROUND

The present disclosure relates to an information processing apparatus configured to execute informational processes in accordance with contents of one or more settings items, and an automatic setting method executed on the information processing apparatus.

For example, when starting a printing process for printing an image on a sheet, the contents of one or more settings items related to the printing process are set in accordance with a user operation. On the other hand, a technology is known in which settings contents preferred by a user are predicted based on past usage frequency of settings contents of a printing process set through a user operation. With this type of technology, since the settings contents preferred by the user can be set automatically, time and effort required by the user for settings operations can be reduced.

### SUMMARY

An information processing apparatus according to one aspect of the present disclosure includes an information processing portion, a first settings-processing portion, a storage processing portion, a count processing portion, and a second settings-processing portion. The information processing portion is configured to execute an informational process in accordance with contents of one or more settings items set in advance. The first settings-processing portion is configured to display, as initial-settings contents set in advance, the contents of the settings items, and change the contents of the settings items in accordance with a user operation. The storage processing portion is configured to, every time the information process is executed, overwrite and store the contents of the settings items as a single history data-set stored in a storage portion. The count processing portion is configured to count a total number of times the informational process has been consecutively set and executed with contents identical to the contents of the settings items in the history data-set by the first settings-processing portion. The second settings-processing portion is configured to set the contents of the settings items in the history data-set as the initial-settings contents when the total number of times counted by the count processing portion has reached a threshold set in advance.

An automatic setting method according to another aspect of the present disclosure is a method of causing a processor to execute first to fifth steps. In the first step, an informational process is executed in accordance with contents of one or more settings items set in advance. In the second step, the contents of the settings item are displayed as initial-settings contents set in advance, and the contents of the settings items are changed in accordance with a user operation. In the third step, the contents of the settings items are overwritten and stored as a single history data-set stored in a storage portion every time the informational process is executed. In the fourth step, a total number of times the informational process has been consecutively set and executed with contents identical to the contents of the settings items in the history data-set in the second step is counted. In the fifth step, the contents of the settings items in the history data-set is set as the initial-settings content when the total number of times counted in the fourth step has reached a threshold set in advance.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an external configuration of an image forming apparatus according to an embodiment of the present disclosure.

FIG. 2 is a block diagram showing a system configuration of the image forming apparatus according to the embodiment of the present disclosure.

FIG. 3 shows one example of a display screen displayed on the image forming apparatus according to the embodiment of the present disclosure.

FIG. 4A shows one example of first settings information used in the image forming apparatus according to the embodiment of the present disclosure.

FIG. 4B shows one example of second settings information used in the image forming apparatus according to the embodiment of the present disclosure.

FIG. 5 is a flowchart showing one example of steps in a settings control process executed by the image forming apparatus according to the embodiment of the present disclosure.

FIG. 6 shows one example of the display screen displayed on the image forming apparatus according to the embodiment of the present disclosure.

FIG. 7 shows one example of the display screen displayed on the image forming apparatus according to the embodiment of the present disclosure.

FIG. 8 shows another example of the second settings information used in the image forming apparatus according to the embodiment of the present disclosure.

FIG. 9 is a flowchart showing another example of the steps in the settings control process executed by the image forming apparatus according to the embodiment of the present disclosure.

### DETAILED DESCRIPTION

In the following, embodiments of the present disclosure will be described with reference to the accompanying drawings to enable understanding of the present disclosure. The embodiments described in the following are examples realizing the present disclosure, and do not limit the technical scope of the present disclosure.

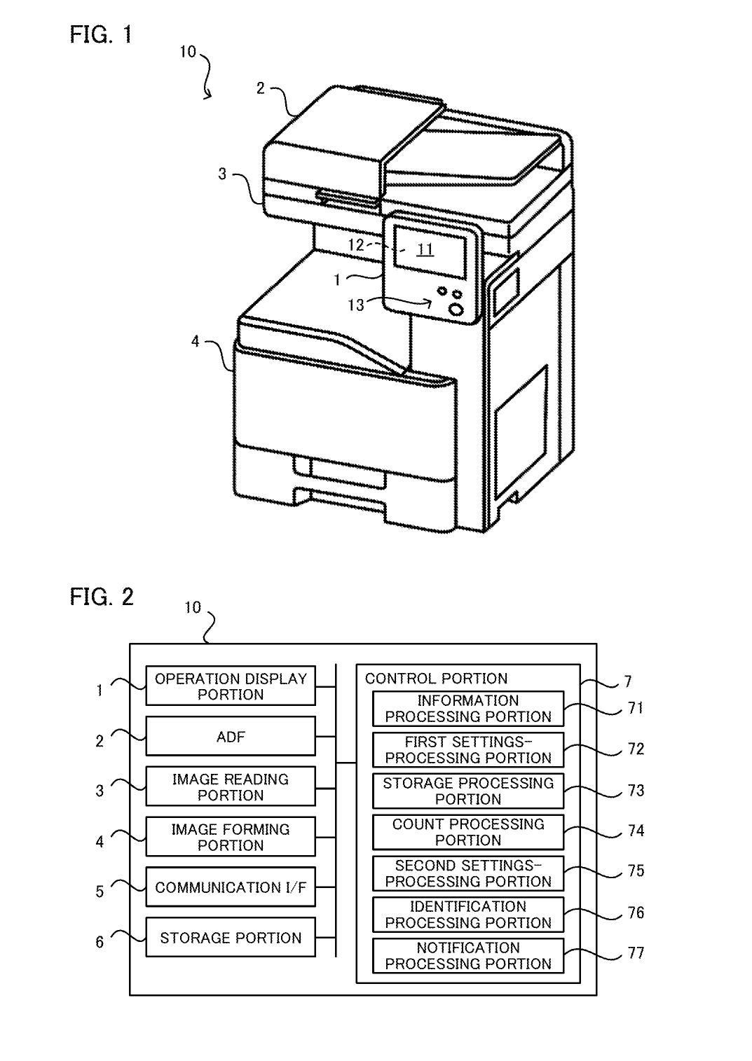

As shown in FIGS. 1 and 2, an image forming apparatus 10 according to an embodiment of the present disclosure includes an operation display portion 1, an ADF 2, an image reading portion 3, an image forming portion 4, a communication I/F 5, a storage portion 6, and a control portion 7. Specifically, the image forming apparatus 10 is a multifunctional peripheral capable of executing various informational processes such as a printing process, a scanning process, a copying process, and a facsimile communication process. The image forming apparatus 10 is one example of an information processing apparatus configured to execute an information process in accordance with contents of one or more settings items set in advance. The information processing apparatus according to the present disclosure is not limited to the image forming apparatus, and may be various electronic devices such as, for example, a personal computer, a smart phone, a tablet terminal, or a mobile terminal.

The operation display portion 1 includes a display portion 11 such as a liquid crystal display for displaying information, and a touch panel 12 and operation buttons 13 for accepting a user operation. The touch panel 12 includes, for example, an electrostatic capacitance type touch sensor disposed on the front surface of the display portion 11, and can detect a touch operation on the display portion 11 by a user. The operation buttons 13 include, for example, a start button, a cancel button, and a stop button.

The ADF 2 is an automatic document sheet conveying device that includes a document sheet setting portion, a conveying roller, a document sheet holding portion, and a sheet discharge portion, etc., and conveys a document sheet to be read by the image reading portion 3. The image reading portion 3 includes a document sheet table, a light source, a mirror, an optical lens, and a CCD (Charge Coupled Device), and reads, and outputs as image data, an image from a document sheet conveyed by the ADF 2 or a document sheet placed on the document sheet table.

The image forming portion 4 can execute the printing process with an electrophotographic method or an ink-jet method based on the image data. For example, when the image forming portion 4 is an electrophotographic type image forming portion, the image forming portion 4 includes a photoconductor drum, a charger, an exposure device, a developing device, a transfer device, and a fixing device, etc.

The communication I/F 5 is a communication interface capable of executing the communication process in accordance with a predetermined communication protocol with an external information processing apparatus such as a facsimile device or a personal computer via a communication network such as a telephone line, the Internet, or a LAN.

The storage portion 6 is a nonvolatile storage portion such as a hard disk or an EEPROM (registered trademark). On the storage portion 6, various control programs executed by the control portion 7, and later described first settings information T1 and second settings information T2 related to settings for the various informational processes executed by the image forming apparatus 10 are stored.

The control portion 7 includes control instruments such as a CPU, a ROM, and a RAM. The CPU is a processor configured to execute various computation processes. The ROM is a nonvolatile storage portion in which information such as control programs configured to cause the CPU to execute various processes is stored in advance. The RAM is a volatile or nonvolatile storage portion used as a temporary storage memory (workspace) for the various processes executed by the CPU.

The control portion 7 executes, by the CPU, the control programs stored in the ROM or the storage portion 6. Specifically, the control portion 7 executes various informational processes such as the printing process, the scanning process, the copying process, and the facsimile communication process in accordance with the control programs. For example, in the scanning process, image data is read from a document sheet by the image reading portion 3. Furthermore, in the copying process, image data is read from a document sheet by the image reading portion 3, and an image is formed on a sheet based on the image data.

Before starting various informational processes such as the scanning process or the copying process, the control portion 7 sets contents of one or more settings items regarding the informational process in accordance with a user operation performed on the operation display portion 1. On the other hand, for example, a technology is known in which settings contents preferred by a user are predicted based on past usage frequency of settings contents of the printing process set through a user operation. However, in order to make a prediction based on the past usage frequency of the settings contents preferred by the user, the past settings contents have to be accumulated and stored, and a large storage capacity becomes necessary for the storage portion. In response, the image forming apparatus 10 can suppress the required storage capacity while reducing the time and effort required for a settings operation by the user.

Specifically, the control portion 7 includes an information processing portion 71, a first settings-processing portion 72, a storage processing portion 73, a count processing portion 74, a second settings-processing portion 75, an identification processing portion 76, and a notification processing portion 77. The control portion 7 functions as the respective processing portions by executing various processes in accordance with the control programs. One or more of the processing portions of the control portion 7 may be an electronic circuit.

The information processing portion 71 executes the informational process in accordance with the contents of one or more settings items set in advance. Specifically, in the image forming apparatus 10, the information processing portion 71 executes, as the informational process, the printing process, the scanning process, the copying process, and the facsimile communication process, etc. For example, the settings items corresponding to the copying process include, for example, paper size, scaling, density, double-sided printing, page aggregation, and collating.

The first settings-processing portion 72 can display, as initial-settings contents set in advance, the contents of the settings items, and change the contents of the settings items in accordance with a user operation performed on the operation display portion 1. Specifically, the first settings-processing portion 72 displays a settings screen D1 used for setting up the settings items on the display portion 11 of the operation display portion 1 in a state in which the contents of settings items are set as the initial-settings contents. The layout, etc., of the settings screen D1 is stored for each of the informational processes such as the printing process, the scanning process, the copying process, and the facsimile communication process executed by the image forming apparatus 10.

The initial-settings contents corresponding to each of the settings items are stored in the first settings information T1 and the second settings information T2 stored in the storage portion 6. The first settings information T1 may be stored in the ROM of the control portion 7.

The first settings information T1 and the second settings information T2 are stored for each of the informational processes such as the printing process, the scanning process, the copying process, and the facsimile communication process executed by the image forming apparatus 10. Furthermore, the second settings information T2 is stored in association with each user of the image forming apparatus 10. The users of the image forming apparatus 10 also include a shared user who can use the image forming apparatus 10 without the need for any login authentication.

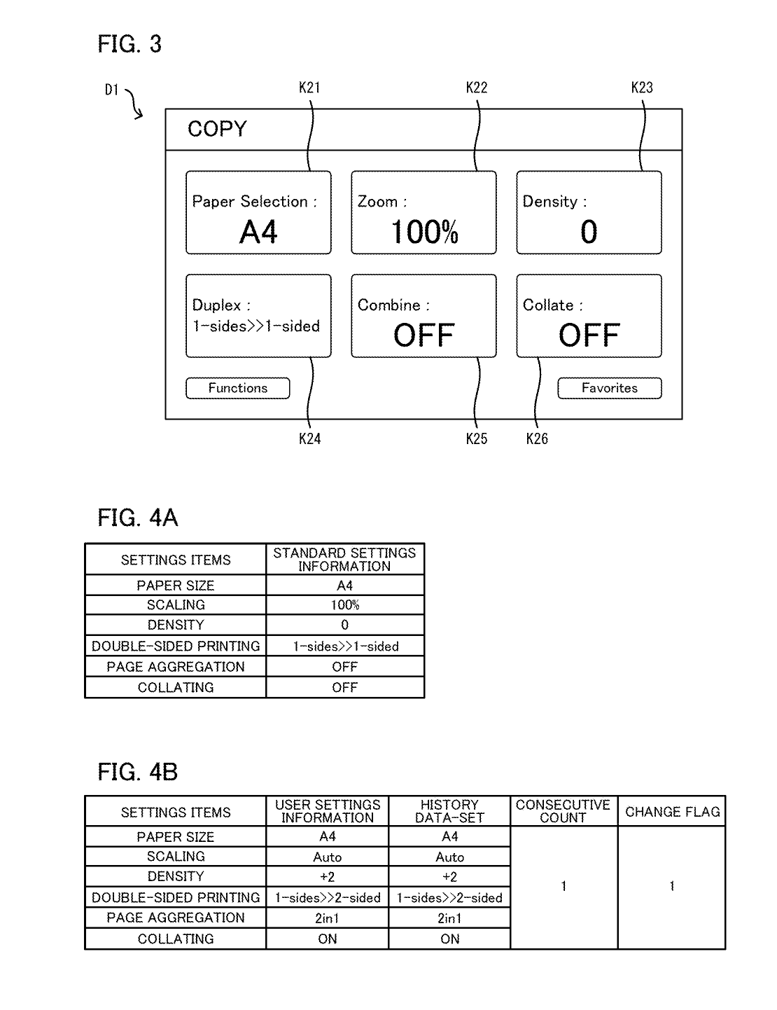

FIG. 3 shows one example of the settings screen D1 corresponding to the copying process. As shown in FIG. 3, on the settings screen D1, a plurality of operation keys K21 to K26 corresponding to a plurality of settings items are displayed. Specifically, operation keys K21, K22, K23, K24, K25, and K26 are operation keys respectively corresponding to settings items of paper size, scaling, density, double-sided printing, page aggregation, and collating involved in the copying process.

The control portion 7 accepts settings operations for the settings items corresponding to the operation keys K21 to K26 in accordance with operation of the operation keys K21 to K26 on the settings screen D1. For example, when the operation key K21 is operated, the control portion 7 displays, on the display portion 11 of the operation display portion 1, a list of paper sizes that can be used with the image forming apparatus 10, and accepts a selection operation of a paper size as a settings operation for the paper size. When the operation key K22 is operated, the control portion 7 displays, on the display portion 11 of the operation display portion 1, a plurality of candidates for scaling rates and an input portion through which a scaling rate can be inputted freely, and accepts, as a settings operation for scaling, a selection operation of a scaling rate or an operation to input a numerical value to the input portion.

FIG. 4A shows one example of the first settings information T1 corresponding to the copying process, and FIG. 4B shows one example of the second settings information T2 corresponding to the copying process. As shown in FIG. 4A, standard settings information for each of the settings items is stored in the first settings information T1. As shown in FIG. 4B, the second settings information T2 includes information such as user settings information, a history data-set, a consecutive count, and a change flag. In the present embodiment, the standard settings information and the user settings information are examples of the initial-settings contents.

The standard settings information in the first settings information T1 includes unchangeable settings contents that are for each of the settings items and are set in advance for when the image forming apparatus 10 is manufactured or shipped, etc. On the other hand, the user settings information in the second settings information T2 includes settings contents that are for each of the settings items and can be freely set in accordance with a user operation on the operation display portion 1 during initial setup. The control portion 7 may have the ability to reset the user settings information to the standard settings information in accordance with a user operation. In a later described settings control process, the control portion 7 can automatically set the user settings information in the second settings information T2. Until the user settings information is set, the user settings information is not stored in the second settings information T2. The initial-settings contents of the user settings information may be set to the same contents as the first settings information T1.

The history data-set included in the second settings information T2 includes settings contents that are for each of the settings items and concern only the most recent informational process among the informational processes corresponding to the second settings information T2 executed by the image forming apparatus 10.

In the consecutive count included in the second settings information T2, information regarding the total number of times the informational process corresponding to the second settings information T2 has been consecutively executed with contents identical to the contents of the settings items in the history data-set is stored.

The change flag included in the second settings information T2 is information showing whether or not the user settings information has been automatically changed based on the history data-set. The change flag is initially “0,” and is changed to “1” when the user settings information has been automatically changed in the settings control process described later.

The storage processing portion 73 overwrites and stores the contents of each of the settings items as a single history data-set stored in the storage portion 6 every time the informational process is executed. Thus, in the image forming apparatus 10, only a single history data-set is stored for respective second settings information T2, and the history data-set is overwritten and stored every time the informational process is executed.

The count processing portion 74 counts the total number of times the informational process has been consecutively executed with contents identical to the contents of the settings items in the history data-set by the first settings-processing portion 72, and stores the total number of times as the consecutive count included in the second settings information T2. With this, the control portion 7 can identify the total number of times the informational process has been consecutively executed with contents identical to the contents of the settings item in the history data-set, by referring the consecutive count.

When the consecutive count counted by the count processing portion 74 reaches a threshold set in advance, the second settings-processing portion 75 automatically sets the contents of the settings items in the history data-set as the user settings information. The threshold is a numerical value indicating the total number of times such as, for example, three times or five times. The control portion 7 can change the threshold in accordance with a user operation performed on the operation display portion 1 in the initial settings, system settings, or the like of the image forming apparatus 10.

The identification processing portion 76 executes a login process for identifying users of the image forming apparatus 10. For example, the identification processing portion 76 identifies the users by executing a login authentication process for a user in response to an input operation of a user ID or password on the operation display portion 1. The contents of the login authentication of a user is not limited to that described above, and, for example, a user may be identified based on information of a card read by a card reader provided to the image forming apparatus 10.

When the user settings information is changed by the second settings-processing portion 75, the notification processing portion 77 generates a notification about the change in the user settings information. For example, when the user settings information is changed, the second settings-processing portion 75 displays, only during a notification period set in advance, a message indicating the change on the display portion 11 of the operation display portion 1, and then erases the message.

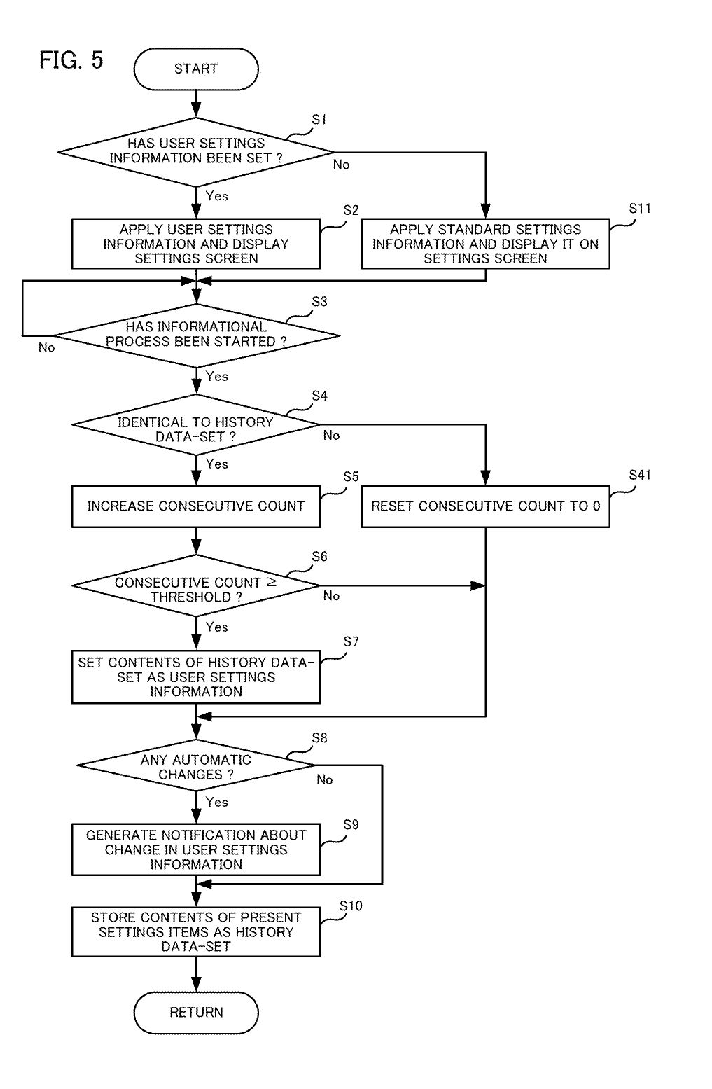

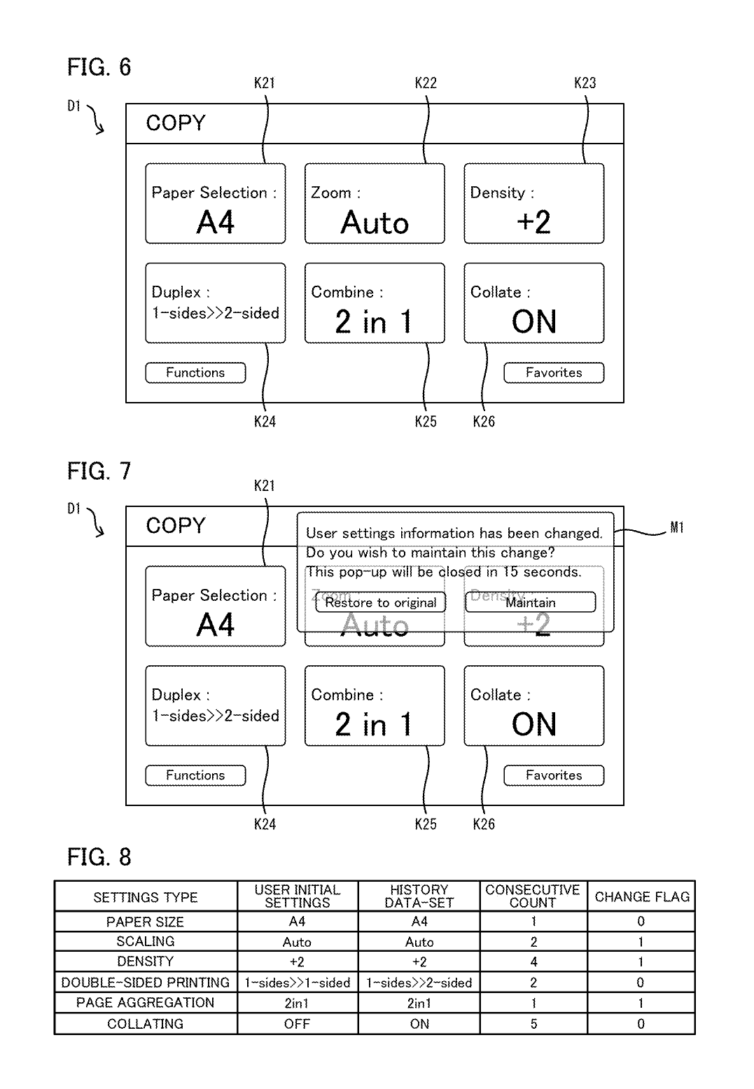

In the following, one example of the steps in the settings control process executed by the control portion 7 in the image forming apparatus 10 will be described with reference to FIG. 5. Here, steps S1, S2, . . . each represent the number of a process step (step) executed by the control portion 7. FIGS. 6 and 7 show a display example of the settings screen D1 displayed on the image forming apparatus 10 as a result of the settings control process. Although the settings control process is described here as an example corresponding to a case in which the copying process is executed as the informational process, a similar settings control process is executed also in other informational processes such as the printing process the scanning process, or the facsimile communication process.

<Step S1>

At step S1, the control portion 7 determines whether or not the user settings information is set in the second settings information T2 stored, in the storage portion 6, correspondingly to the present user of the image forming apparatus 10. The present user of the image forming apparatus 10 is identified by the identification processing portion 76. When an identifiable user is not logged into the image forming apparatus 10, the control portion 7 refers to the second settings information T2 corresponding to the shared user. Here, when the user settings information has been set (S1: Yes), the process transitions to step S2; whereas when the user settings information has not been set (S1: No), the process transitions to step S11.

<Step S11>

At step S11, the control portion 7 applies the standard settings information in the first settings information T1 and displays the settings screen D1 on the display portion 11 of the operation display portion 1. Specifically, the control portion 7 displays the settings screen D1 in a state in which the contents of various settings items included in the standard settings information are reflected in the contents of various settings items on the settings screen D1. FIG. 3 shows an initial display state of the settings screen D1 corresponding to a case in which the standard settings information shown in FIG. 4 is set. The standard settings information is one example of the initial-settings contents, and step S11 is executed by the first settings-processing portion 72 of the control portion 7.

<Step S2>

At step S2, the control portion 7 applies the user settings information in the second settings information T2 stored in the storage portion 6 in association with the present user and the contents of the informational process, and displays the settings screen D1 on the display portion 11 of the operation display portion 1. Specifically, the control portion 7 displays the settings screen D1 in a state in which the contents of various settings items included in the user settings information are reflected in the contents of various settings items on the settings screen D1. FIG. 6 shows an initial display state of the settings screen D1 corresponding to a case in which the user settings information shown in FIG. 4 is set. The user settings information is one example of the initial-settings contents, and step S2 is executed by the first settings-processing portion 72 of the control portion 7.

<Step S3>

At step S3, the control portion 7 determines whether or not a request to start the informational process has been made. Specifically, the control portion 7 determines that a request to start the informational process has been made in accordance with operation of a start key included in the operation buttons 13 of the operation display portion 1. When the request to start the informational process is determined to be made (S3: Yes), the process transitions to step S4. On the other hand, unless the request to start the informational process is made (S3: No), the control portion 7 accepts settings operations of each of the settings items in accordance with a user operation on the settings screen D1. The control portion 7 starts executing the informational process in response to the request to start the informational process, but description thereof is omitted here.

<Step S4>

At step S4, the control portion 7 determines whether or not the contents of each of the settings items set on the settings screen D1 are identical to the contents of the respective settings items included in the history data-set, and causes the process to diverge accordingly. Specifically, the control portion 7 determines whether or not the contents of all the settings items set on the settings screen D1 are identical to the contents of the settings items included in the history data-set.

When the contents of all the settings items are determined to be identical to those in the history data-set (S4; Yes), the process transitions to step S5; whereas when determined not to be identical (S4; No), the process transitions to step S41. The control portion 7 may determine whether or not, among all the settings items set on the settings screen D1, contents of one or more specific settings items set in advance are identical to the contents of the settings items included in the history data-set. In this case, for example, it is possible to only exclude, from items to be determined, a settings item such as the number of sheets to be printed.

<Step S5>

At step S5, the control portion 7 adds “1” to the consecutive count in the second settings information T2 stored in the storage portion 6 in association with the present user and the contents of the informational process. More specifically, at steps S4 and S5, the total number of times the informational process has been consecutively executed with contents completely identical to the contents of the plurality of the settings items in the history data-set is counted for each user. Steps S4 and S5 are executed by the count processing portion 74 of the control portion 7. With this, the control portion 7 can identify the total number of times the informational process has been consecutively executed with contents identical to those in the history data-set by referring to the consecutive count.

<Step S41>

At step S41, the control portion 7 resets, to “0,” the consecutive count in the second settings information T2 stored in the storage portion 6 in association with the present user and the contents of the informational process, and causes the process to transition to step S8. Even when the consecutive count is reset, the user settings information in the second settings information T2 is not erased.

<Step S6>

At step S6, the control portion 7 determines whether or not the consecutive count in the second settings information T2 is equal to or larger than the threshold set in advance. When the consecutive count is determined to be equal to or larger than the threshold (S6; Yes), the process transitions to step S7; whereas when the consecutive count is determined not to be equal to or larger than the threshold (S6; No), the process transitions to step S8.

<Step S7>

At step S7, the control portion 7 sets, as the user settings information corresponding to each of the settings items, the contents of each of the settings items in the history data-set in the second settings information T2 stored in the storage portion 6 in association with the present user and the contents of the informational process. More specifically, when the same informational process has been consecutively executed with the same settings contents by the same user for the threshold number of times or more, the control portion 7 automatically sets the settings contents as the user settings information. Thus, the user settings information is set individually for each user. With this, when the informational process is to be executed next, a state in which the user settings information is reflected is displayed as the initial display state of the settings screen D1. The processes of steps S6 and S7 are executed by the second settings-processing portion 75 of the control portion 7.

At step S7, the control portion 7 sets the change flag of the second settings information T2 to “1” indicating that the user settings information has been automatically changed. With this, the control portion 7 can identify whether or not the user settings information has be automatically set based on the history data-set. The change flag is reset to “0” when the user settings information has been erased or when the user settings information has been reset to the standard settings information.

<Step S8>

As step S8, the control portion 7 determines whether or not the user settings information in the second settings information T2 has been automatically changed based on the history data-set. Specifically, when the change flag of the second settings information T2 is “1,” the control portion 7 determines that the user settings information has been automatically changed based on the history data-set. When the user settings information is determined to have been automatically changed based on the history data-set (S8; Yes), the process transitions to step S9; whereas when determined not to have been automatically changed (S8; No), the settings control process ends.

<Step S9>

At step S9, the control portion 7 generates a notification about the user settings information being automatically changed at step S7 only during a notification period set in advance. Step S9 is executed by the notification processing portion 77 of the control portion 7. Thus, as a result of steps S8 and S9, when the user settings information has been changed for the informational process, the control portion 7 generates the notification about the user settings information being changed every time the informational process is executed.

Specifically, the control portion 7 notifies the user about the user settings information being automatically changed by displaying a pop-up on the settings screen D1. Then, the control portion 7 ends displaying the pop-up when the notification period has elapsed. For example, as shown in FIG. 7, a pop-up screen M1 containing a message about the user settings information being automatically changed is displayed on the settings screen D1. In addition, the background of the pop-up screen M1 is displayed as transparent or semi-transparent as shown in FIG. 7. With this, the user can visually observe the settings contents of each of the settings items on the settings screen D1.

As shown also in FIG. 7, the control portion 7 displays, on the pop-up screen M1, operation keys for selecting whether or not to maintain the change in the user settings information. When an operation to maintain is performed, or when an operation is not been performed before the display of the pop-up screen M1 has disappeared, the control portion 7 continues the state in which the user settings information is changed. On the other hand, when an operation to restore to the original is performed, the control portion 7 erases the user settings information or resets the user settings information to the standard settings information. With this, the user can easily erase or reset the user settings information.

As a result, when the user settings information has been automatically changed based on the history data-set, the user can identify the change every time the informational process is executed, and can select whether or not to maintain the change to the user settings information. Executing the process at step S9 only once when the user settings information has been automatically changed based on the history data-set is conceivable as another embodiment.

<Step S10>

Then, at step S10, the control portion 7 overwrites and stores the contents of each of the settings item set in the present informational process onto the second settings information T2 as the history data-set. Thus, in the second settings information T2, only the history data-set for a single informational process executed lastly is overwritten and stored, sequentially. Step S10 is executed by the storage processing portion 73 of the control portion 7.

As describe above, in the image forming apparatus 10, the user settings information in the second settings information T2 is automatically updated based on the history data-set and the consecutive count. More specifically, the history data-set is automatically set as the user settings information under a condition that the consecutive count showing the total number of times the informational process has been consecutively executed with contents identical to that of the history data-set has reached the threshold. With this, time and effort required by the user for settings operations can be reduced, since settings contents preferred by the user is automatically set. Since only a single history data-set and the numerical value of the consecutive count are needed to be stored in the second settings information T2, the storage capacity required for the storage portion 6 can be reduced when compared to, for example, storing a plurality of the history data-sets.

[Other Embodiments]

In the embodiment described above, a case has been described in which, in the settings control process, the consecutive count is being increased or reset depending on whether or not all settings items in the history data-set of the second settings information T2 are completely identical. However, as described in the following, in the settings control process, the total number of times the informational process has been consecutively executed with contents identical to the contents of the settings items in the history data-set is conceivably counted individually for each of the settings items.

FIG. 8 shows one example of the second settings information T2 that is used when the process is executed for each of the settings items in the settings control process. As shown in FIG. 8, in the second settings information T2, the consecutive count and the change flag can be stored for each of the settings items.

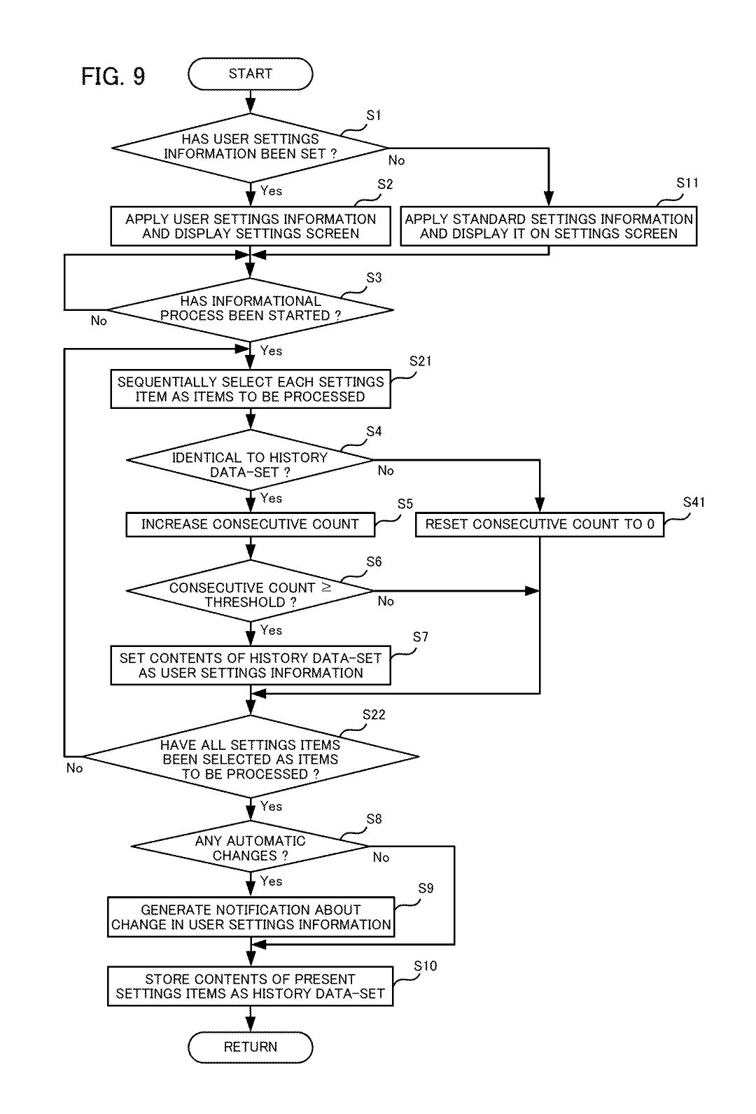

FIG. 9 is a flowchart showing one example of the settings control process when the process is executed for each of the settings items. In FIG. 9, processes similar to those in the settings control process (see FIG. 5) are given the same identification characters.

<Step S21>

In the settings control process shown in FIG. 9, at a stage before step S4, the process of step S21 is executed. At step S21, the control portion 7 sequentially selects each of the settings items as an item to be processed, and executes the processes at and subsequent to step S4 for the selected settings item.

<Step S22>

On the other hand, at step S22, the control portion 7 determines whether or not all the settings items have been selected as items to be processed. When all the settings items have been determined as being selected as items to be processed (S22; Yes), the process transitions to step S8; whereas when not all the settings items have been determined as being selected as items to be processed (S22; No), the process is returned to step S21.

With this, in the settings control process, the control portion 7 determines whether or not the contents of the settings items in the history data-set are the same for each of the settings items set on the settings screen D1 (S4). Here, the control portion 7 increases the consecutive count for, among the settings items, a settings item that is identical to the contents of a settings item in the history data-set (S5). In addition, the control portion 7 resets the consecutive count for, among the settings items, a settings item that is not identical to the contents of a settings item in the history data-set (S41).

For the settings item whose consecutive count has reached or exceeded the threshold (S6; Yes), the control portion 7 sets the contents of the history data-set as the user settings information (S7). Thus, only the user settings information corresponding to the settings item whose consecutive count counted at step S5 has reached the threshold is set as the contents of the settings item in the history data-set. For example, when the copying process is executed consecutively by the threshold or more with “paper size” being set to “A3,” only “paper size” in the user settings information is set to “A3” even when other settings items are different. The threshold may be a different value for each of the settings items.

At step S8 and S9, the control portion 7 conceivably executes a notification process when at least one of the change flags for the settings items in the user settings information is set to “1.”

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An information processing apparatus comprising:
an information processing portion configured to execute an informational process in accordance with contents of one or more settings items set in advance;
a first settings-processing portion configured to display, as initial-settings contents set in advance, the contents of the settings items, and change the contents of the settings items in accordance with a user operation;
a storage processing portion configured to, every time the informational process is executed, overwrite and store the contents of the settings items as a single history data-set stored in a storage portion;
a count processing portion configured to count a total number of times the informational process has been consecutively executed with contents identical to the contents of the settings items in the history data-set by the first settings-processing portion; and
a second settings-processing portion configured to set the contents of the settings items in the history data-set as the initial-settings contents when the total number of times counted by the count processing portion has reached a threshold set in advance.

2. The information processing apparatus according to claim 1, wherein
the count processing portion counts the total number of times the informational process has been consecutively executed with contents completely identical to the contents of the plurality of the settings items in the history data-set, and
the second settings-processing portion sets contents of each of the settings items in the history data-set to each of the initial-settings contents corresponding to each of the settings items.

3. The information processing apparatus according to claim 1, wherein
the count processing portion counts, individually for each of the settings items, a total number of times the informational process has been consecutively executed with contents identical to the contents of the settings items in the history data-set, and
the second settings-processing portion sets, as the contents of the settings items in the history data-set, only the initial-settings contents corresponding to the settings items whose total number of times counted by the count processing portion has reached the threshold.

4. The information processing apparatus according to claim 1, further comprising an identification processing portion configured to identify users of the information processing apparatus, wherein
the storage processing portion is configured to cause the storage portion to store the single history data-set for each of the users,
the count processing portion is configured to count the total number of times for each of the users, and
the second settings-processing portion is configured to set the initial-settings contents for each of the users.

5. The information processing apparatus according to claim 1, further comprising a notification processing portion configured to generate, when the initial-settings contents are changed by the second settings-processing portion, a notification about a change in the initial-settings contents.

6. The information processing apparatus according to claim 5, wherein the notification processing portion is configured to display a pop-up about the change in the initial-settings content on a settings screen used for setting contents of the settings items by the first settings-processing portion.

7. The information processing apparatus according to claim 6, wherein a background of a screen of the pop-up about the change in the initial-settings contents displayed on the settings screen is transparent or semi-transparent.

8. The information processing apparatus according to claim 5, wherein the notification processing portion is configured to generate, when the initial-settings contents are changed by the second settings-processing portion, a notification about a change in the initial-settings content every time the informational process is executed.

9. The information processing apparatus according to claim 1, wherein the informational process is a printing process, a copying process, a scanning process, or a facsimile communication process.

10. An automatic setting method of causing a processor to execute:
a first step of executing an informational process in accordance with contents of one or more settings items set in advance;
a second step of displaying, as initial-settings contents set in advance, the contents of the settings items, and changing the contents of the settings items in accordance with a user operation;
a third step of, every time the informational process is executed, overwriting and storing the contents of the settings items as a single history data-set stored in a storage portion;
a fourth step of counting a total number of times the informational process has been consecutively set and executed with contents identical to the contents of the settings items in the history data-set in the second step; and
a fifth step of setting the contents of the settings items in the history data-set as the initial-settings contents when the total number of times counted in the fourth step has reached a threshold set in advance.
